(19) United States
(12) Patent Application Publication
(10) Pub. No.: US 2007/0033186 A1
(43) Pub. Date: Feb. 8, 2007

(54) Computer-based employment matching system and method

(76) Inventor: Patricia S. Cinkle, Santa Ana, CA (US)

Correspondence Address: VENABLE LLP, P.O. BOX 34385, WASHINGTON, DC, 20043-9998, US

(21) Appl. No.: 11/497,343

(22) Filed: Aug. 2, 2006

Related U.S. Application Data
(60) Provisional application No. 60/704,422, filed on Aug. 2, 2005.

(51) Int. Cl. G06F 17/30

(52) U.S. Cl. 707/6

(57) ABSTRACT

A computer-based employment matching method, system and computer program product is provided. The method may include the step of receiving electronically first computer-readable data from an employer via a computer network, the first computer-readable data representing a job profile including a first set of decision information selected by the employer from a predetermined set of decision information and a first set of criteria selected by the employer from a predetermined set of criteria based on the first set of decision information. The method may further include the steps of receiving electronically second computer-readable data from a job seeker via a computer network, the second computer-readable data representing a job search profile, comparing the first computer-readable data to the second computer-readable data, and transmitting electronically one of information associated with the job seeker to the employer if the first computer-readable data matches the second computer-readable data or a notification to the job seeker to transmit information associated with the job seeker to the employer if the first computer-readable data matches the second computer-readable data.

### BACKGROUND OF THE INVENTION

1. Field of the Invention

The present invention relates generally to employment matching systems and methods, and more particularly to computer-based and network-based employment matching systems and methods.

2. Related Art

Businesses and other organizations are constantly seeking new employees to fill available positions. Numerous resources and methods are available to assist such organizations in this endeavor. Known employment search and recruiting systems and methods may begin with an employer posting a job. For example, one possible recruiting method utilized by employers is direct advertising in print media such as in the classified section of a newspaper or trade magazine. A typical employment advertisement may, for example, generally include a brief description of the available position, along with the contact information of the employer. Based on the information in the advertisement, job seekers may apply for the position by, for example, forwarding personal resumes directly to the employer. An employer's human resources department, for example, may then manually screen submitted resumes to identify the applicants best suited for a particular position.

There are several disadvantages inherent in print media recruiting methods and the like. For example, newspapers and magazines may generally have a limited distribution region and, even then, may only have a limited number of subscribers within that region. Therefore, an employer's print advertisement might not be readily available to any number of qualified people and attempts to distribute the advertisement more universally, for example, through additional print media in other regions, may substantially increase advertising expenses incurred by the employer.

Furthermore, such print media advertising methods may become even more expensive and inefficient after the organization receives resumes in response. For example, the resumes may need to be manually organized and screened to select suitable candidates. That is, a person in the organization's recruitment or human resources department may need to spend a significant amount of time sorting and screening applicant materials.

In order to avoid manual screening inefficiencies, computer-based resume screening software programs have been developed which can be configured to screen a collection of resumes for the most qualified candidates. Resumes received by organizations using such software may first be scanned or uploaded into a computer and stored. The computer running the resume screening software may then be controlled to search the resumes for various attributes, such as college degrees, prior experience, special qualifications, and the like. The computer may then provide output such as, for example, a list of qualified candidates. Thus, computerized screening and sorting methods allow human resource personnel to avoid manual sorting and enable them to devote more time to other tasks.

Some organizations have begun using computer networks, such as the Internet, in order to increase exposure to available employment opportunities, as well as to take advantage of the aforementioned screening technology in a network setting. For example, an organization may set up a company website on the World Wide Web (WWW) on which they may post various job openings. In this way, anyone who can connect to the Internet can access a company's web site and search for available positions. The website may disclose any positions available at that particular organization, and may further allow a visitor and/or interested job seeker to forward a resume, for example.

One disadvantage of providing such information on a website is that in order for an applicant to see the organization's available positions, the job seeker must be aware that the organization exists and has a website on the Internet. Consequently, if the job seeker has never heard of the organization, he or she would not be aware of the organization's website. Therefore, many highly qualified job seekers may overlook an organization's website advertisement because they simply are not aware that the organization exists.

Computer-based and/or network-based employment recruiting systems may be useful tools for enabling organizations to reach a greater number of potential applicants. Such systems may also allow an organization to organize and/or screen resumes that are received. For example, U.S. Pat. No. 6,370,510 to McGovern et al., filed Sep. 7, 1999, is directed to an Employment Recruiting System and Method Using a Computer Network for Posting Job Openings and Which Provides for Automatic Periodic Searching of the Posted Job Openings. Similarly, U.S. Pat. No. 5,978,768, teaches a Computerized Job Search System and Method for Posting and Searching Job Openings via a Computer Network. Both of the foregoing references are incorporated by reference herein in their entirety. The conventional systems and methods taught by the aforementioned patents still have drawbacks, however. For example, such systems allow job seekers to view all available positions that have been posted regardless of their qualifications and further allow all job seekers to submit resumes to respective posting organizations. Furthermore, although these systems provide resume sorting tools to assist the posting organizations in the search for qualified job seekers, the tools generally involve resume keyword searching programs which may not provide an effective sorting mechanism given the wide variety of terms and phrases that may be used by a job seeker when building his or her resume.

Therefore, a continuing need exists for an employer-centric computer-based employment matching system and method which will enable an employer to effectively and efficiently screen and categorize interested job seekers.

### BRIEF SUMMARY OF THE INVENTION

An exemplary embodiment of the present invention is directed to a computer-based employment matching method, system and computer program product. The method may include, in an exemplary embodiment, the step of receiving electronically first computer-readable data from an employer via a computer network, the first computer-readable data representing a job profile including a first set of decision information selected by the employer from a predetermined set of decision information and a first set of criteria selected by the employer from a predetermined set of criteria based on the first set of decision information. The method may further include the steps of receiving electronically second computer-readable data from a job seeker via a computer network, the second computer-readable data representing a job search profile, comparing the first computer-readable data to the second computer-readable data, and transmitting electronically one of information associated with the job seeker to the employer if the first computer-readable data matches the second computer-readable data or a notification to the job seeker to transmit information associated with the job seeker to the employer if the first computer-readable data matches the second computer-readable data.

The system may include, in an exemplary embodiment, a data receiving module adapted to electronically receive first computer-readable data from an employer via a computer network, the first computer-readable data representing a job profile including a first set of decision information selected by the employer from a predetermined set of decision information and a first set of criteria selected by the employer from a predetermined set of criteria based on the first set of decision information. The data receiving module may be further adapted to electronically receive second computer-readable data from a job seeker via a computer network, the second computer-readable data representing a job search profile. The system may further include a comparing module adapted to compare the first computer-readable data to the second computer-readable data and a transmitting module adapted to electronically transmit one of information associated with the job seeker to the employer if the first computer-readable data matches the second computer-readable data or a notification to the job seeker to transmit information associated with the job seeker to the employer if the first computer-readable data matches the second computer-readable data.

Further features and advantages, as well as the structure and function of exemplary embodiments will become apparent from a consideration of the following description, drawings, and examples.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements. The left-most digits in the corresponding reference numerals indicate the drawing in which an element first appears.

FIG. 1 depicts a schematic view of a computer-based network for an employment matching system and method according to an exemplary embodiment of the present invention;

FIG. 2 depicts an exemplary site map for an employment matching system and method according to an exemplary embodiment of the present invention;

FIG. 3 depicts a flowchart of an exemplary job seeker signup process according to an exemplary embodiment of the present invention;

FIG. 4 depicts a flowchart of an exemplary employer signup process according to an exemplary embodiment of the present invention;

FIG. 5 depicts a flowchart of an exemplary job profile creation process according to an exemplary embodiment of the present invention;

FIG. 6 depicts a flowchart of an exemplary job search profile creation process according to an exemplary embodiment of the present invention;

FIG. 7 depicts a flowchart of an exemplary data comparison process according to an exemplary embodiment of the present invention;

FIG. 8 depicts a flowchart of an exemplary online skills verification portion of a job profile creation process according to an exemplary embodiment of the present invention; and

FIGS. 9-25 depict screen displays according to an exemplary embodiment of the present invention.

### DETAILED DESCRIPTION OF EMBODIMENTS OF THE INVENTION

Exemplary embodiments of the invention are discussed in detail below. In describing embodiments, specific terminology is employed for the sake of clarity. The invention, however, is not intended to be limited to the specific terminology so selected. Although specific exemplary embodiments are discussed, it should be understood that this is done for illustration purposes only. A person skilled in the relevant art will recognize that other components and configurations can be used without parting from the spirit and scope of the invention. All references cited herein are incorporated by reference as if each had been individually incorporated.

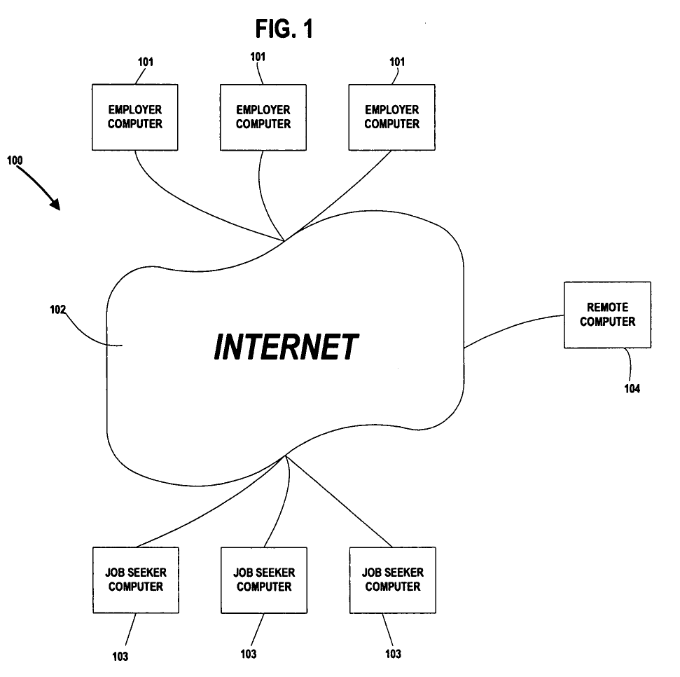

Referring to the drawings, FIG. 1 depicts a schematic view of a computer-based network for an employment matching system and method according to an exemplary embodiment of the present invention. In an exemplary embodiment of the invention, the computer-based network 100 may include one or more computers 101 and one or more computers 103, a network 102, and one or more remote computers 104. Computer 101 may be operated by an employer which may have employment positions available. Computer 103 may be operated by a job seeker who may be searching for employment positions. The computers 101 and 103 may be coupled to one another in the computer-based network 100 via, for example, the Internet 102 and may run software embodied on a computer-readable medium according to an exemplary embodiment of the present invention. A remote computer 104 may also be coupled to the computers 101 and 103 via network 100 and the Internet 102. The remote computer 104 may also run software embodied on a computer-readable medium according to an exemplary embodiment of the present invention. The software, in an exemplary embodiment, may be built on a .NET platform available from MICROSOFT CORPORATION of Redmond, Wash., U.S.A., with custom controls using, for example, a structured query language (SQL) 7.0 database and may allow for integration with third party applications and future upgrades.

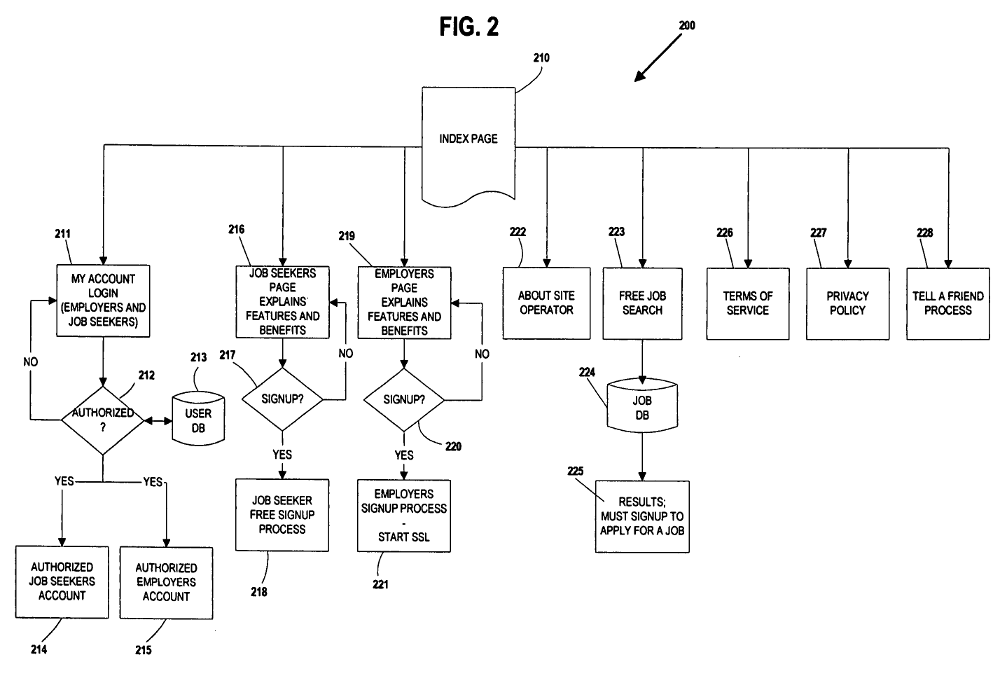

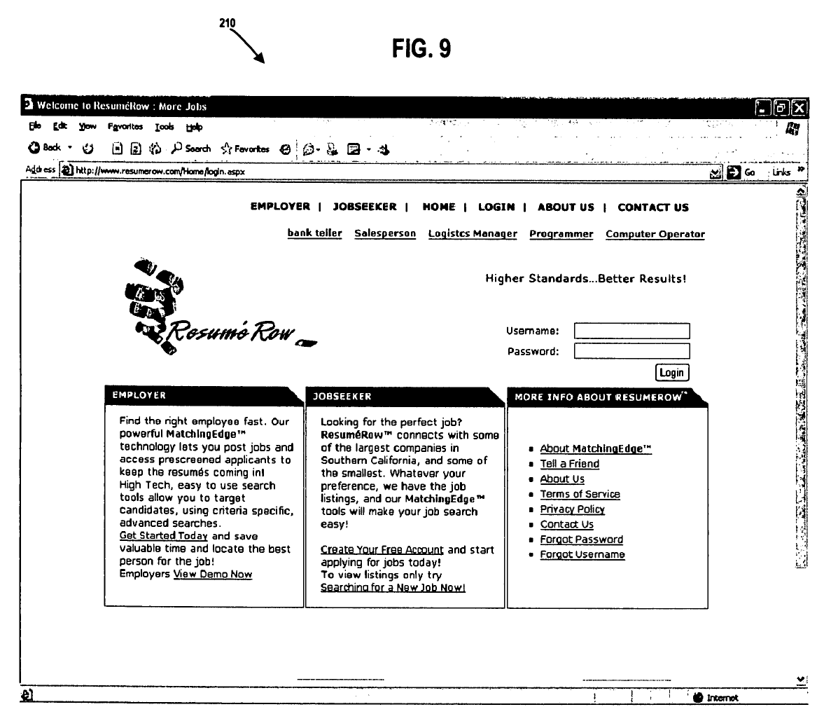

FIG. 2 depicts an exemplary site map for an employment matching system and method according to an exemplary embodiment of the present invention. The site map 200 may include an index page 210 on a site such as, for example, a web site on the World Wide Web, that may allow a user, such as, for example, an employer or a job seeker, to view and/or link to a plurality of available options on the site. FIG. 9 shows a screen shot of an exemplary index page 210 according to an exemplary embodiment of the invention. Referring again to FIG. 2, the index page 210 may, for example, allow an employer or a job seeker to login to an existing user account at block 211. The index page 210 may also allow an employer or a job seeker to view details regarding features and benefits provided to job seekers at block 216, view details regarding features and benefits provided to employers at block 219, view details regarding the site operator at block 222, conduct a free job search at block 223, view details regarding terms of service at block 226, view details regarding privacy policy at block 227, and/or provide a process by which an employer or a job seeker can tell a friend about the site at block 228.

An employer or a job seeker may, for example, elect to login at block 211 to an existing user account from the index page 210 using login information such as, for example, a username and a password. The login information may be verified at block 212 by comparing the login information with information stored in a user database 213. If the login information is not verified, the employer or the job seeker may be returned to the login screen at block 211. If, however, the login information is verified, the employer or job seeker may be authorized to view his or her account. An authorized job seeker may, for example, be allowed to view his or her account and use services provided on the site, as indicated at block 214. Likewise, an authorized employer may, for example, be allowed to view its account and use services provided on the site, as indicated at block 215.

A job seeker may also link from the index page 210 to a job seeker page 216 which may explain the benefits and features of the system and may further allow the job seeker to sign-up for the service, as indicated at block 217. If the job seeker wishes to sign-up for the service, he or she may be taken through a job seeker free sign-up process at block 218. Similarly, an employer may also link from index page 210 to an employer page 219 which may explain the benefits and features of the system and may further allow the employer user to sign-up for the service, as indicated at block 220. If the employer wishes to sign-up, the employer may be taken through an employer sign-up process at block 221.

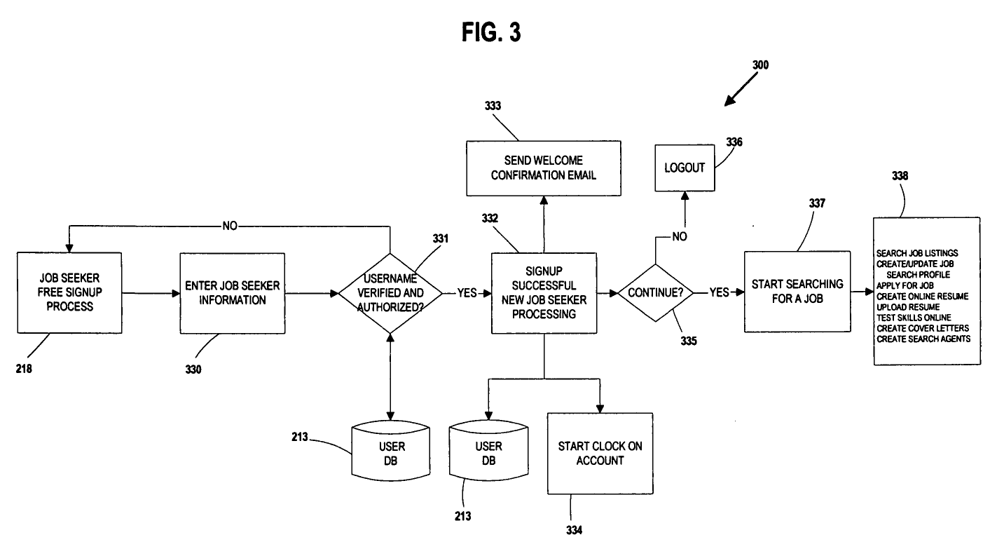

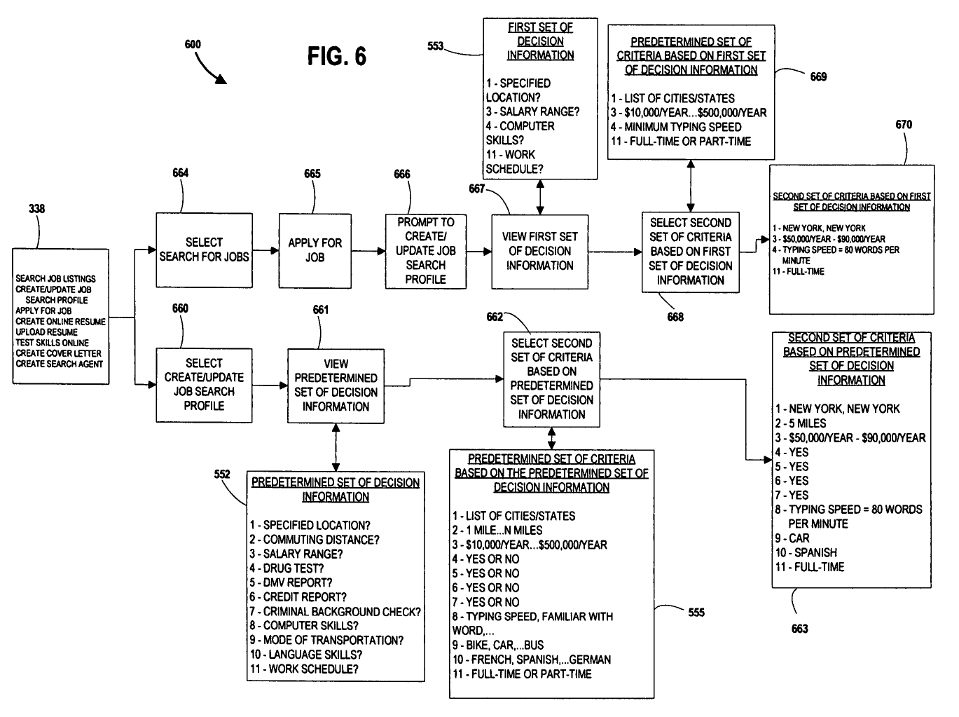

Other links may also be available via the index page 210. For example, a job seeker or an employer may be provided with a link to learn more about the site at block 222 and/or the terms of the service at block 226, the privacy policy at block 227, and may further link to a process that may allow the user to tell-a-friend about the service at block 228. The tell-a-friend process at block 228 is not discussed in further detail herein, but may be understood by a person having ordinary skill in the art to include, for example, sending an email to another employer or job seeker informing them about the site. A job seeker may also perform a free job search at block 223 based on a search of job database 224. The results of the free job search may then be displayed, for example, on a user interface of the job seeker's computer 103. In order to apply for a job displayed in the results at block 225, however, the job seeker may be prompted to sign-up for the service in an exemplary embodiment of the invention. The job seeker sign-up process at block 218 is discussed in further detail below with regard to FIGS. 3 and 6.

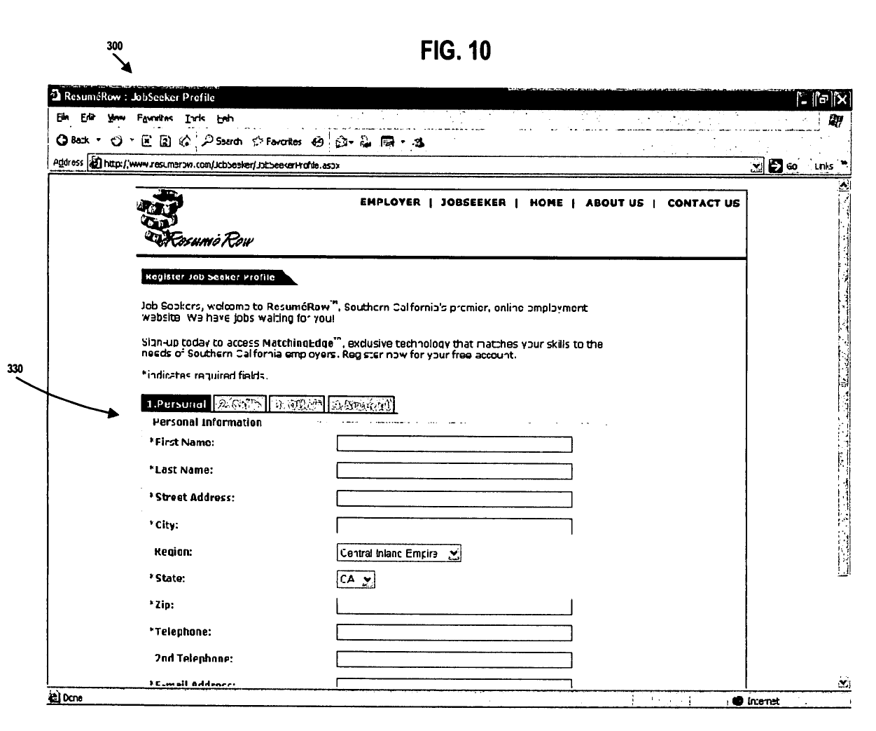

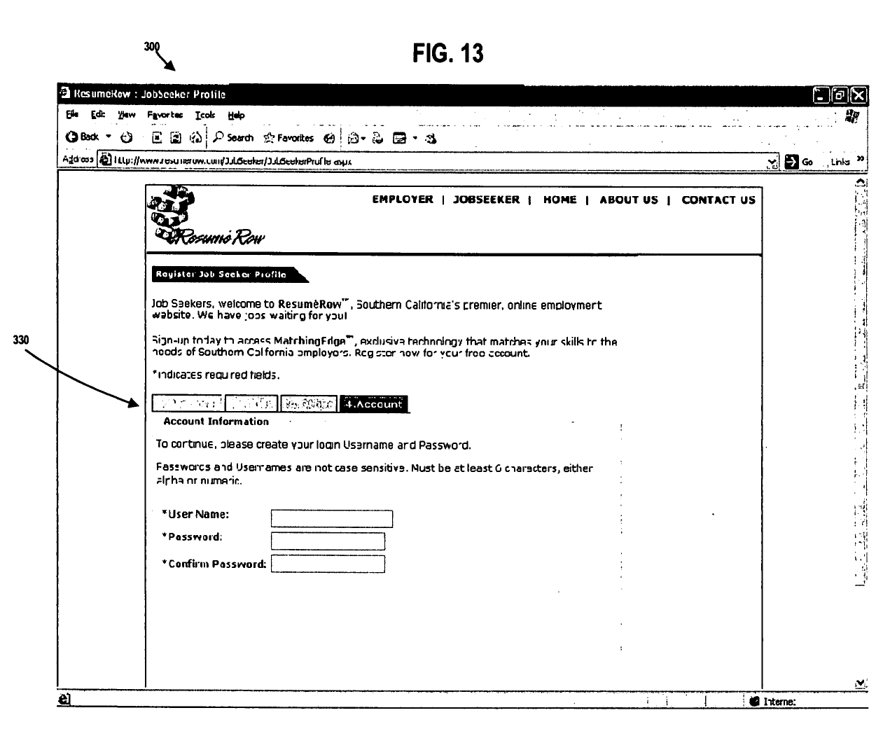

FIG. 3 depicts a flowchart of an exemplary job seeker signup process according to an exemplary embodiment of the present invention. A job seeker accessing the site 200 may elect to sign-up for the service at block 218 and, as a result, may be guided through a job seeker sign-up process 300 via, for example, a series of prompts or tabs. FIGS. 10-13 depict exemplary screen shots that may be seen by a job seeker during a sign-up process 300 according to an exemplary embodiment of the invention. Referring again to FIG. 3, the job seeker may first be prompted at block 330 to input personal information about the job seeker, including, for example, contact information, job seeker skills and other information, and login information including a username and a password. The username and password may be verified and authorized at block 331 by comparison with user data stored in a user database 213. If the username and/or password is not authorized, the job seeker may be returned to sign-up block 218. If, however, the username and password are authorized and the sign-up is successful, the job seeker may be forwarded to a new job seeker processing block 332.

The new job seeker processing block 332 may include, for example, automatically sending a welcome email confirmation at block 333, writing the new job seeker username and password to the user database 213, and/or starting a clock on the job seeker's account at block 334. The account clock may be restarted each time the job seeker signs-in to his or her account and may further be programmed to deactivate the job seeker's account when a specified level of account inactivity is reached such as, for example, failure to sign-in or update account information for a particular amount of time such as, for example, one month according to an exemplary embodiment of the invention. The aforementioned account clock may, for example, enable the user database 213 to be kept current and free of out-dated account information.

A job seeker that is logged-in to his or her account and has completed new job seeker processing at block 332 may be prompted as to whether he or she wishes to continue at block 335. If the job seeker does not wish to continue, he or she may logout at block 336. If the job seeker wishes to continue, however, he or she may start searching for a job at block 337 and may, for example, be provided with a plurality of job seeker tools 338 by which to search for jobs, apply for jobs and/or manage his or her account.

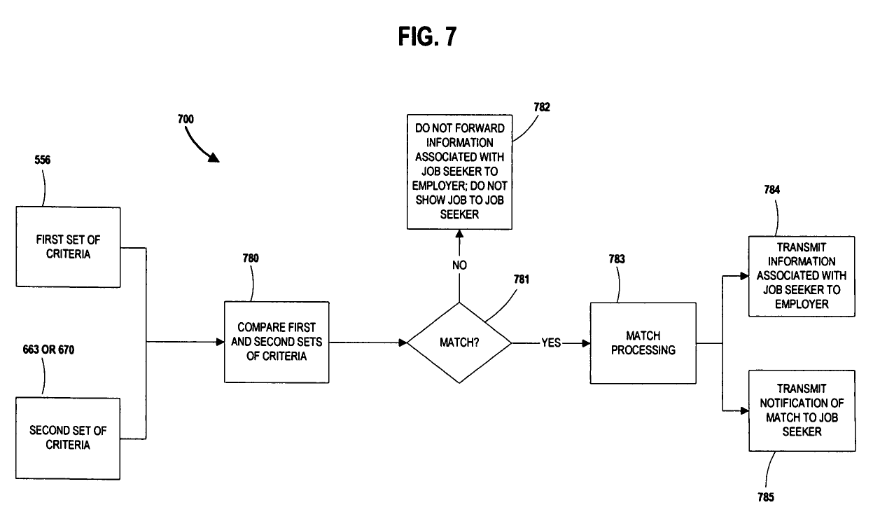

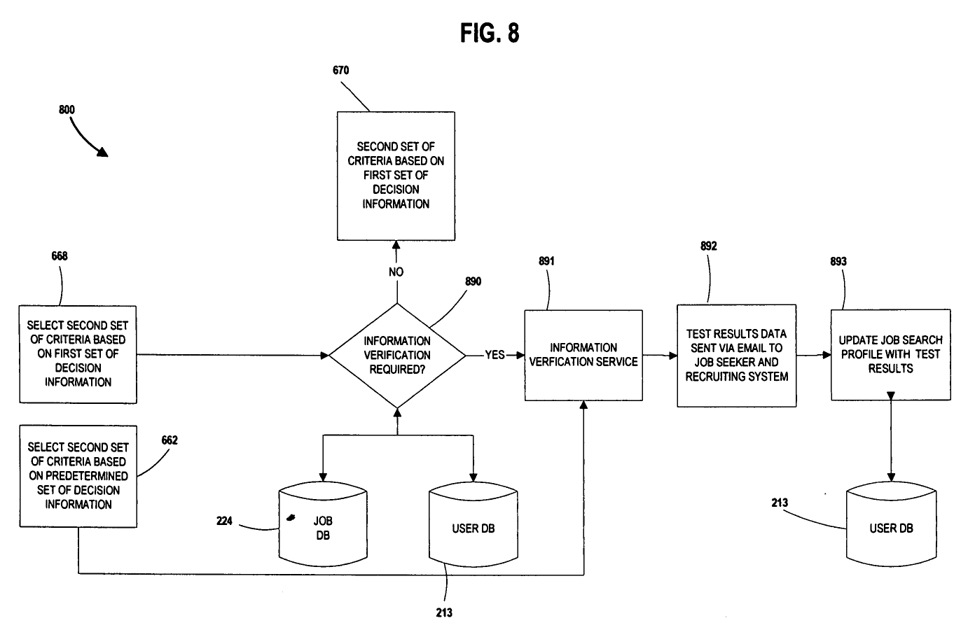

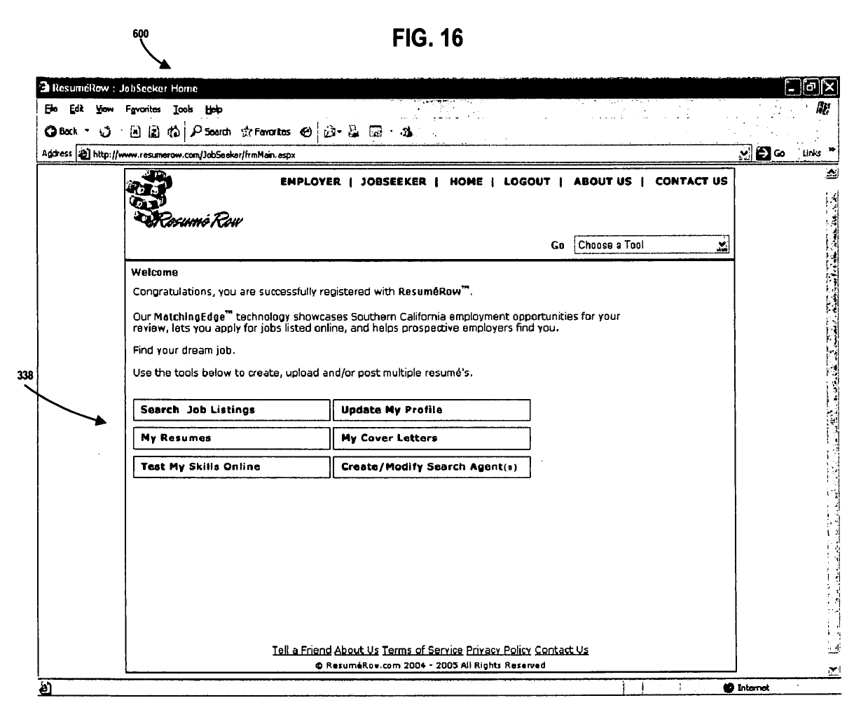

The plurality of job seeker tools 338 may, for example, allow the job seeker to search job listings, create and/or update an online resume, upload a resume, test skills online with an online verification service such as, for example, proveit.com, create and/or update a job search profile, create and/or modify cover letters, and create and/or update search agents. FIG. 16 depicts an exemplary screen shot of the plurality of job seeker tools 338 according to an exemplary embodiment of the invention. The job search profile and the creation thereof are discussed in further detail below with respect to FIG. 6. The exemplary online skills verification portion of a job profile creation process is discussed in further detail below with respect to FIG. 8. Search agents may be used to identify matches between a job seeker job search profile and an employer job profile. In an exemplary embodiment, search agents may perform various functions including, for example, comparisons as depicted in FIG. 7, discussed further below.

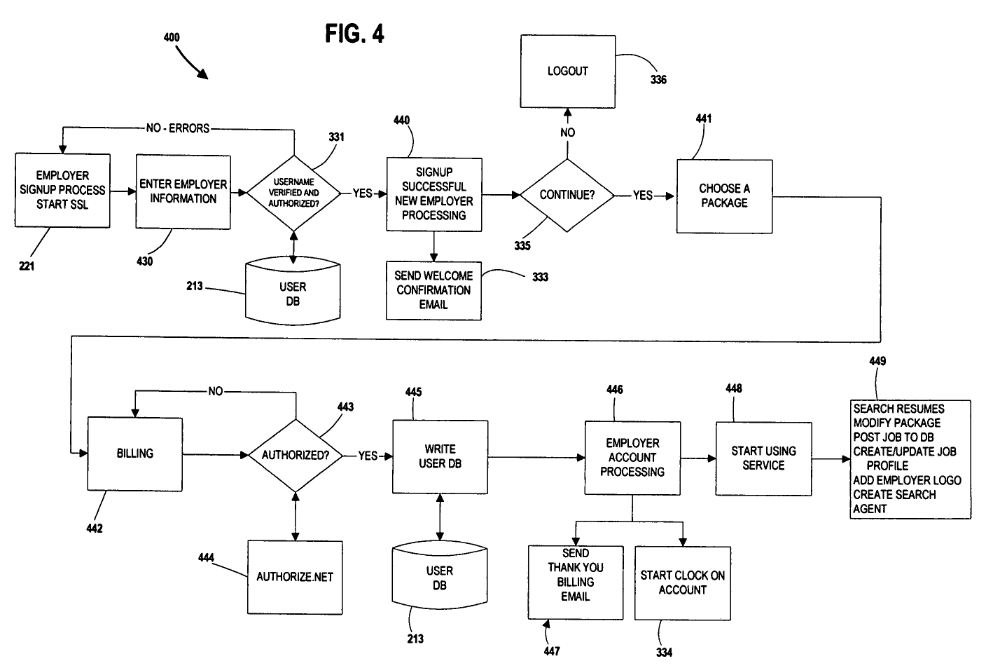

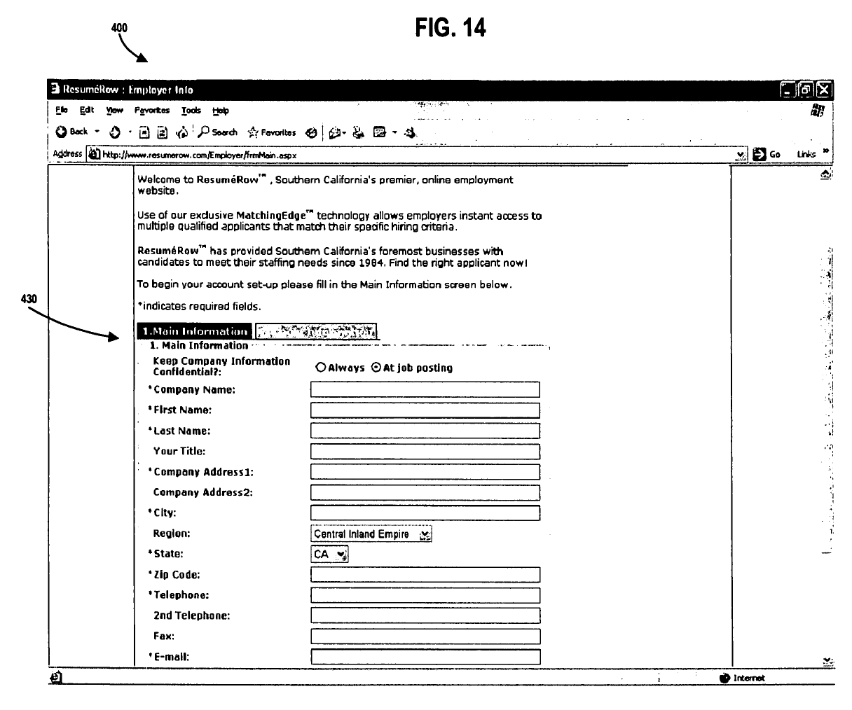

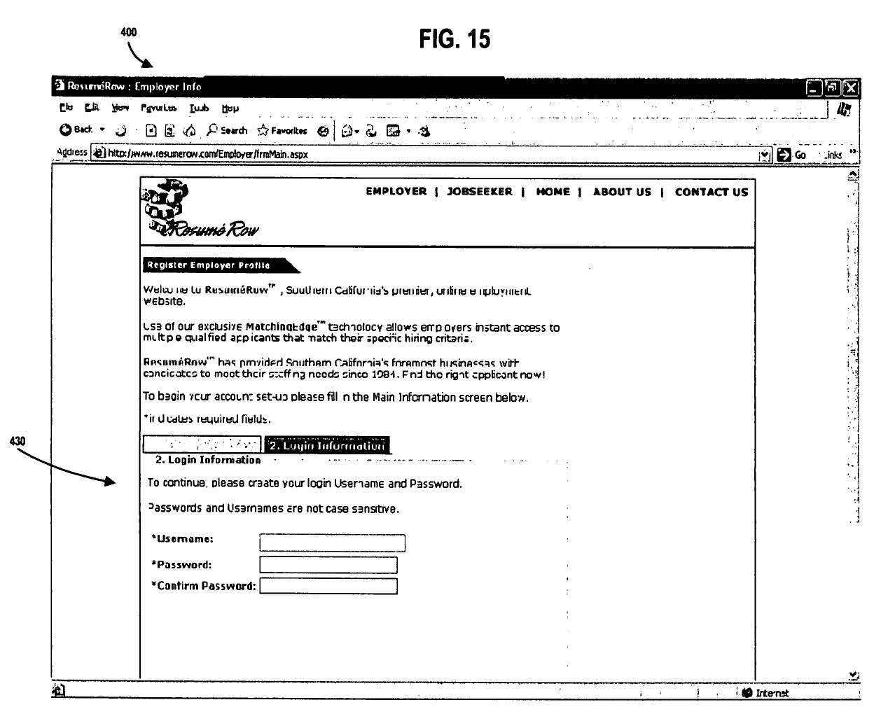

FIG. 4 depicts a flowchart of an exemplary employer signup process according to an exemplary embodiment of the present invention. In an employer signup process 400, an employer user may be guided through an employer sign-up process beginning at block 221 via, for example, a series of prompts or tabs. FIGS. 14 and 15 depict exemplary screen shots that may be seen by an employer during a sign-up process 400 according to an exemplary embodiment of the invention. Referring again to FIG. 4, the employer may first be prompted at block 430 to input information about the employer, including, for example, main contact information and login information including a username and a password. The username and password may be verified and authorized at block 331 by comparison with user data stored in a user database 213. If the username and/or password are not authorized, the employer may be returned to sign-up block 221. If, however, the username and password are authorized and the sign-up is successful, the employer may be forwarded to a new employer processing at block 440. The new employer processing at block 440 may include automatically sending a welcome email confirmation at block 333 to the employer.

An employer that is signed-in to an authorized account and has completed new employer processing at block 440 may be prompted as to whether or not to continue at block 335. If the employer does not wish to continue, the employer may logout at block 336. If the employer wishes to continue, however, the employer may be prompted to choose a service package at block 441 based on various features and benefits required by the employer. The service packages 441 are not discussed in further detail herein, but will be understood by a person having ordinary skill in the art to include, for example, various features and benefits that may be available to an employer based on the employers needs and a price difference, such as the number of posted jobs allowed and the amount of access the employer may have to various search categories.

Once the employer has selected a package at block 441, the employer may be prompted to input data to make arrangements for billing and payment at block 442 for use of the service. Authorization of online billing and payment arrangements at block 443 may include, for example, online verification of the employer's billing input data by Authorize.net at block 444. In an exemplary embodiment of the invention, the billing information may be, for example, verified at block 443 by comparing the billing input information with information stored in an authorize.net database (not shown). If the billing information is not verified, the employer user may be returned to block 442. If, however, the billing information is verified, the employer's billing information may be written to the user database 213 at block 445, and the new employer's account may be setup and processed at block 446.

The new employer account processing at block 446 may also include automatically sending a billing email confirmation at block 447 and/or starting a clock at block 334 on the employer's account. The account clock at block 334 may be restarted each time the employer signs-in to its account and may further be programmed to deactivate the employer's account when a specified level of account inactivity is reached such as, for example, failure to sign-in or update account information for a particular amount of time such as, for example, one month according to an exemplary embodiment of the invention. The aforementioned account clock may, for example, enable the user database 213 to be kept current and free of out-dated account information.

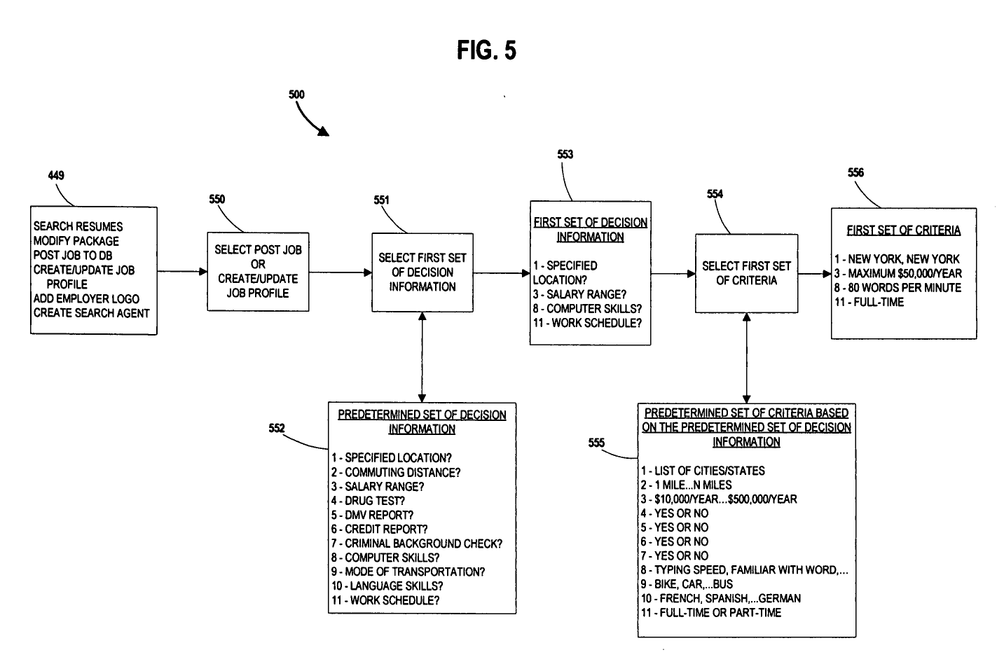

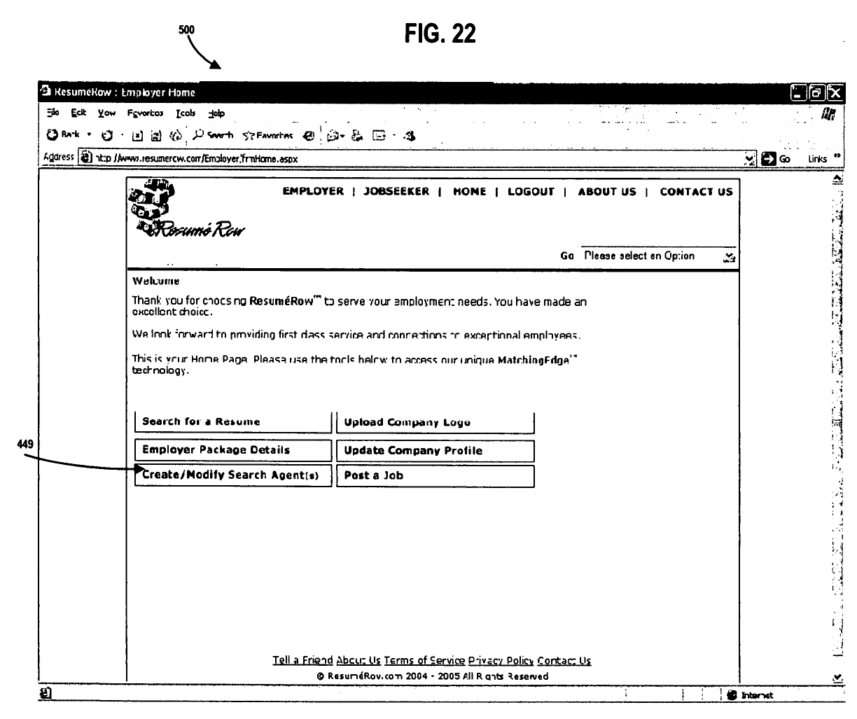

If the employer wishes to start using the service at block 448, the employer may then be provided with a plurality of employer tools 449 by which it may, for example, post jobs and manage its account. The plurality of employer tools 449 may, for example, allow an employer to search job seeker resumes, modify and/or update the chosen service package, add an employer logo, create and/or update a job profile by posting a job to the jobs database 224, and create and/or update search agents. FIG. 22 depicts an exemplary screen shot of an exemplary plurality of employer tools 449 according to an exemplary embodiment of the invention. The job profile and the creation thereof will be discussed in further detail below with respect to FIG. 5.

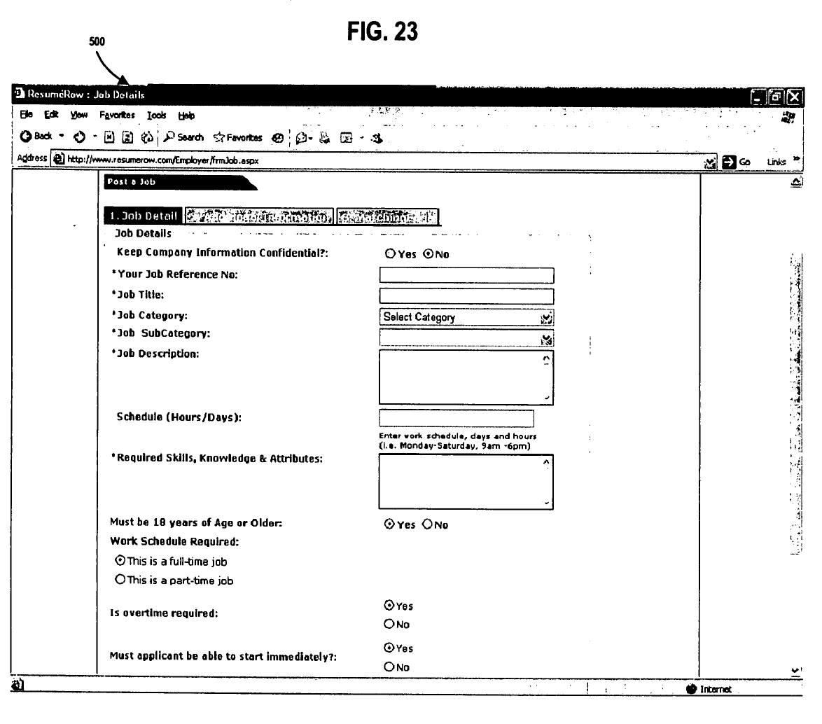

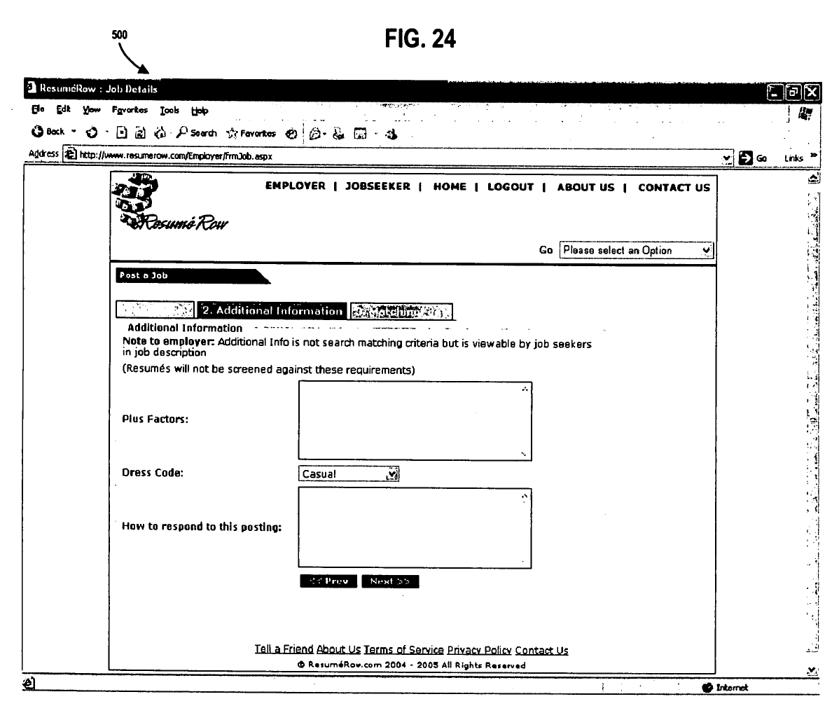

FIG. 5 depicts a flowchart of an exemplary job profile creation process according to an exemplary embodiment of the present invention. In a job profile creation process 500, an employer may post a job or create and/or update a job profile associated with a particular job in order to screen a potential job seeker for compatibility prior to receiving information associated with the respective job seeker. An authorized employer may, for example, be presented with the plurality of employer tools 449 such as, for example as shown in the exemplary screen shot depicted in FIG. 22. The employer may select one of the tools. Referring again to FIG. 5, the employer may choose at block 550, for example, to post a job or to create and/or update a job profile associated with a particular job that may be posted and/or stored in the job database 224. The employer may be prompted at block 551 to select a first set of decision information 553 based on a predetermined set of decision information 552 provided on the site. The first set of decision information 553 may be selected by the employer from the predetermined set of decision information 552 by use of known selection tools such as, for example, a graphical user interface feature, a pull-down menu, a radio button, or a text box. FIGS. 23-25 depict exemplary screen shots showing the process 500 of posting a job and creating and/or updating a job profile associated with a posted job according to an exemplary embodiment of the present invention.

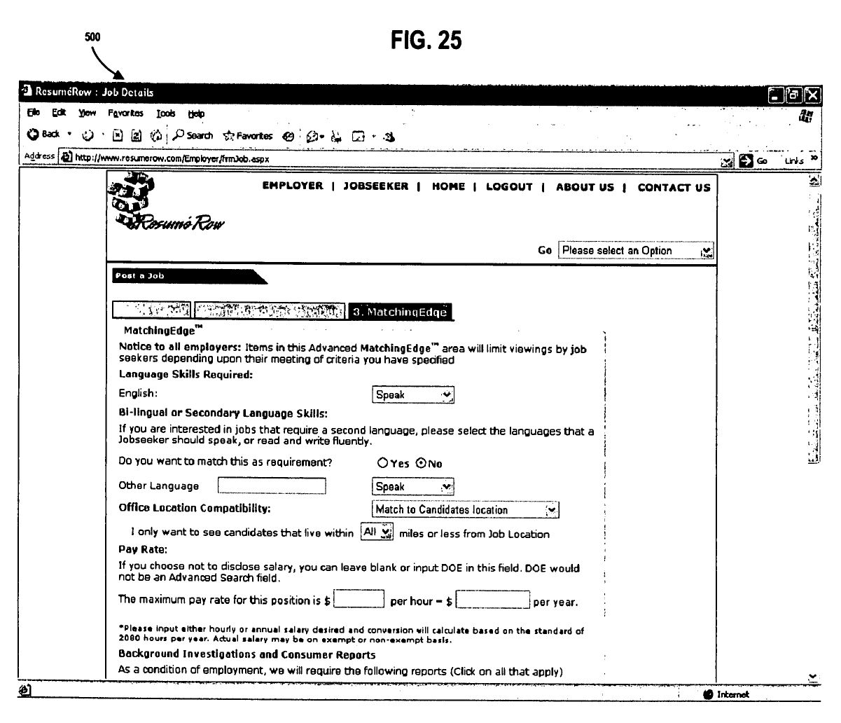

In an exemplary embodiment of the invention, the predetermined set of decision information 552 may include predefined employment screening questions or requirements such as, for example: location information, commuting distance information, salary range information, drug test information, State Department of Motor Vehicles (DMV) report information, criminal background check information, online verification of computer and/or other skills information, mode of transportation information, language skills information, and/or work schedule information. The first set of decision information 553 selected by the employer may include all or some of the foregoing screening questions depending on what the employer believes to be relevant to the associated job position. FIG. 25 depicts an exemplary screen shot showing a first set of decision information 553 based on a predetermined set of decision information 552 provided on the site.

Once the employer has selected the first set of decision information 553 such as, for example, location information, salary range information, online verification information, and work schedule information, the employer may then be prompted at 554 to select a first set of criteria 556 from a predetermined set of criteria 555 based on the first set of decision information 553. The predetermined set of criteria 555 may correspond to the predetermined set of decision information 552 and may include answer lists or options associated with respective screening questions and/or requirements in the predetermined set of decision information 552 such as, for example: lists of cities and/or states; specific commuting distances; specific salary ranges such as, e.g., in dollars per year or dollars per hour; yes or no options; typing speed in words per minute; lists of vehicles or other modes of transportation; lists of different languages; and/or full-time or part-time position options. The first set of criteria 556 may be selected by the employer from the predetermined set of criteria 555 based on the first set of decision information 553 by use of known selection tools such as, for example, a pull-down menu, a radio button, or a text box. FIG. 25 depicts an exemplary screen shot showing a first set of criteria 556 selected by the employer from the predetermined set of criteria 555 based on the first set of decision information 553 according to an exemplary embodiment of the invention.

As an example, referring again to FIG. 5, the employer may select the first set of decision information 553 based on the particular job position and the predetermined set of decision information 552. The first set of decision information 553 selected by the employer may include, for example: location information; salary range information; online verification of typing skills information; and work schedule information. Based on the first set of decision information 553, the employer may then select the first set of criteria 556 from the predetermined set of criteria 555. The first set of criteria 556 may include, for example: New York, N.Y.; a maximum salary of $50,000 per year; a minimum typing speed of 80 words per minute; and a full-time status job. The first set of decision information 553 and the first set of criteria 556 may be stored in the job database 224 (not shown in FIG. 5) and may be associated with the employer or with the particular job. The first set of criteria 556 may be compared to a job seeker's job search profile as further discussed below with respect to FIG. 7.

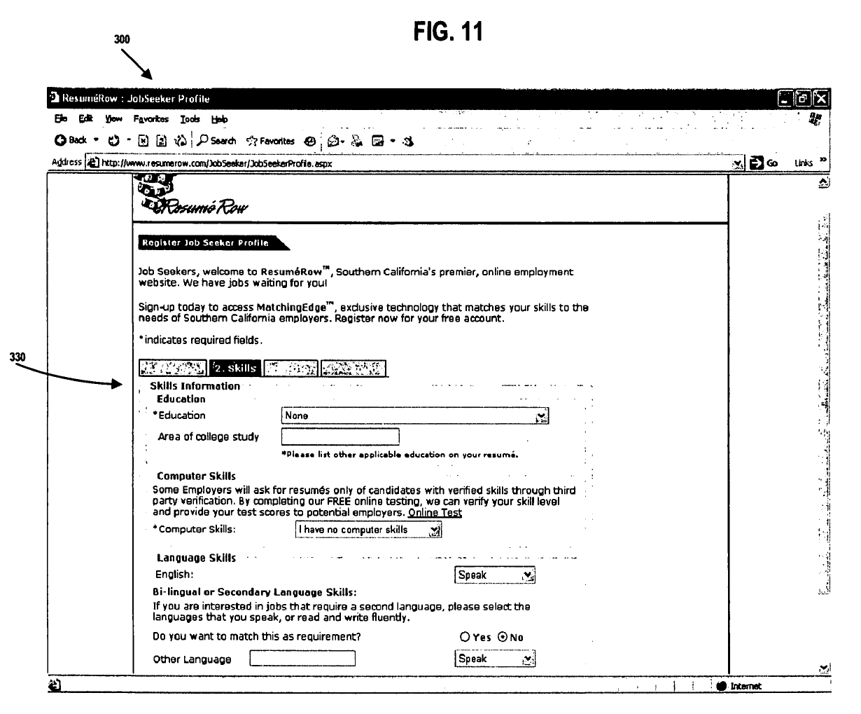

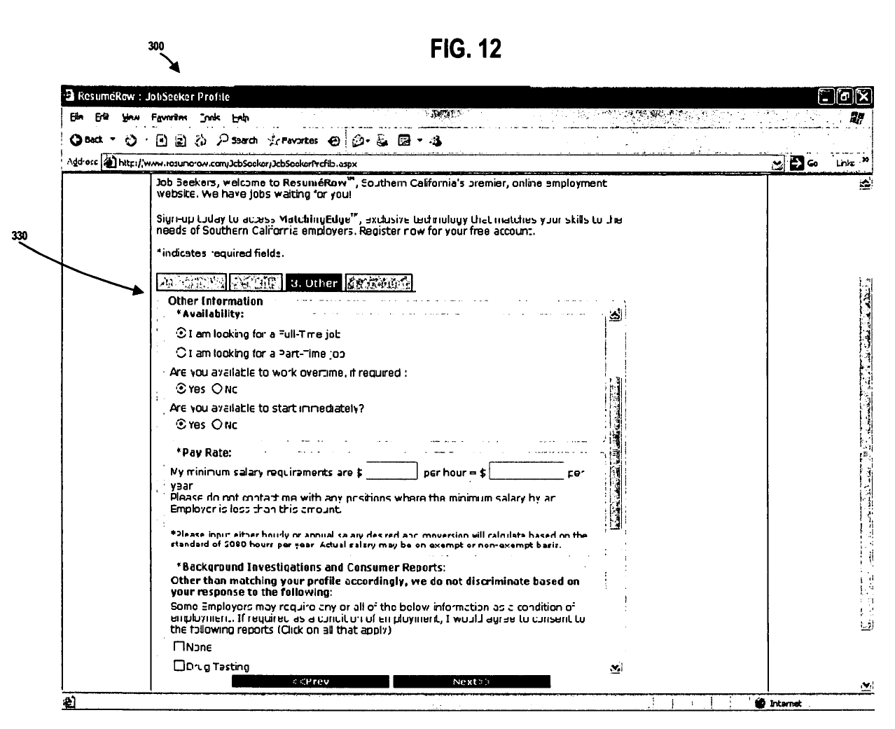

FIG. 6 depicts a flowchart of an exemplary job search profile creation process according to an exemplary embodiment of the present invention. In a job search profile creation process 600, a job seeker may create or update a job search profile associated with the job seeker. The job seeker may, for example, be presented with the plurality of job seeker tools 338. FIG. 16 depicts an exemplary screen shot of the plurality of job seeker tools 338 according to an exemplary embodiment of the invention. Referring again to FIG. 6, the job seeker may select one of the tools at block 660 such as, for example, creating and/or updating a job search profile associated with the job seeker. The job seeker may view, at block 661, a predetermined set of decision information 552 and may select, at block 662, a second set of criteria 663 from a predetermined set of criteria 555 based on the predetermined set of decision information 552. The second set of criteria 663 based on the predetermined set of decision information 552 may be selected by the job seeker from the predetermined set of criteria 555 by use of known selection tools such as, for example, a pull-down menu, a radio button, or a text box. FIGS. 11 and 12 depict exemplary screen shots of a job seeker selecting the second set of criteria 663 from the predetermined set of criteria 555 based on the predetermined set of decision information 552. Both the predetermined set of decision information 552 and the predetermined set of criteria 555 are described in more detail above, with regard to FIG. 5.

As an example, referring again to FIG. 6, the second set of criteria 663 based on the predetermined set of decision information may include, for example: New York, N.Y.; a maximum commuting distance of five miles; a preferred salary range of between $50,000 per year to $90,000 per year; a willingness to submit to a drug testing requirement; a willingness to submit a DMV report; a willingness to submit a current credit report; a willingness to submit to a criminal background check; a willingness to submit to online verification of computer skills; a car being a primary mode of transportation; fluency in Spanish; and a preference for full-time job status. The second set of criteria 663 may be stored in the user database 213 (not shown in FIG. 6) and may be associated with the job seeker. The second set of criteria 663 may be compared to an employer's job profile as further discussed below with respect to FIG. 7.

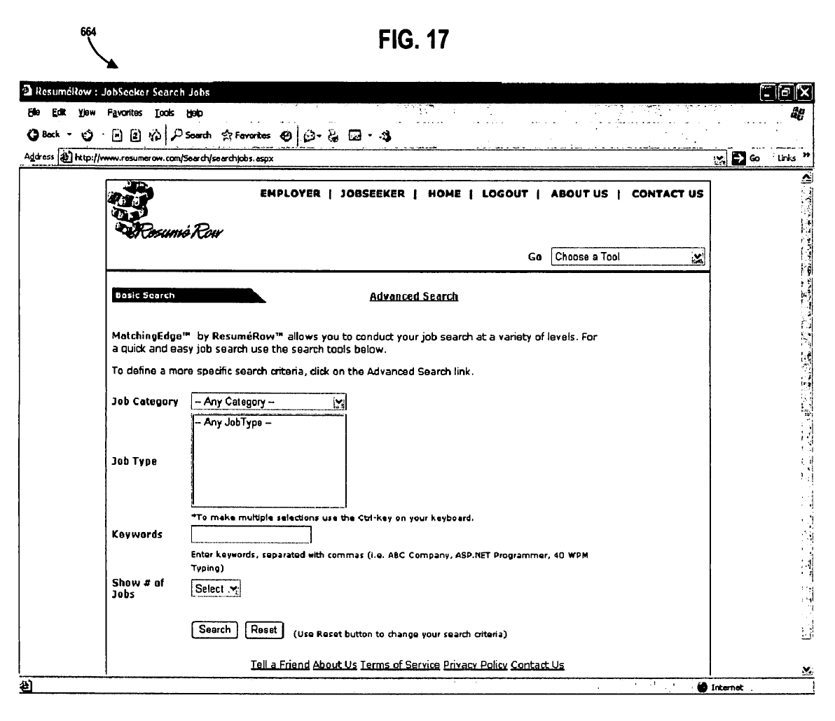

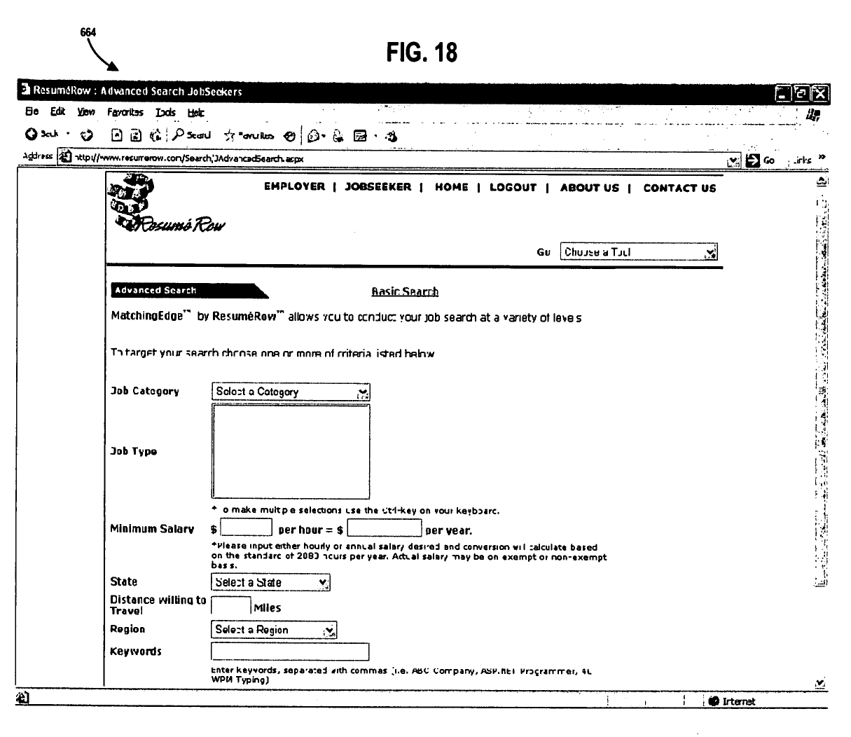

In the job search profile creation process 600, a job seeker may also create or update a job search profile associated with the job seeker once he or she is ready to apply for a particular job posted on the site. The job seeker may, for example, be presented with the plurality of job seeker tools 338. The job seeker may select one of the tools. For example, the job seeker may elect to search for a job at block 664. FIGS. 17-18 depict exemplary screen shots of a job seeker searching for a job according to an exemplary embodiment of the invention. A basic job search and an advanced job search may both be available as shown in FIGS. 17 and 18.

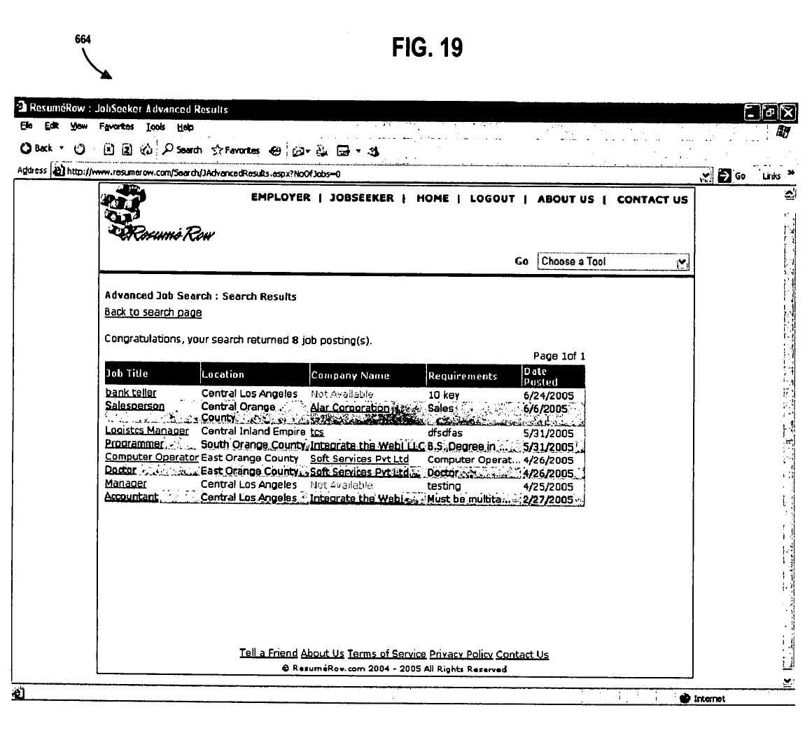

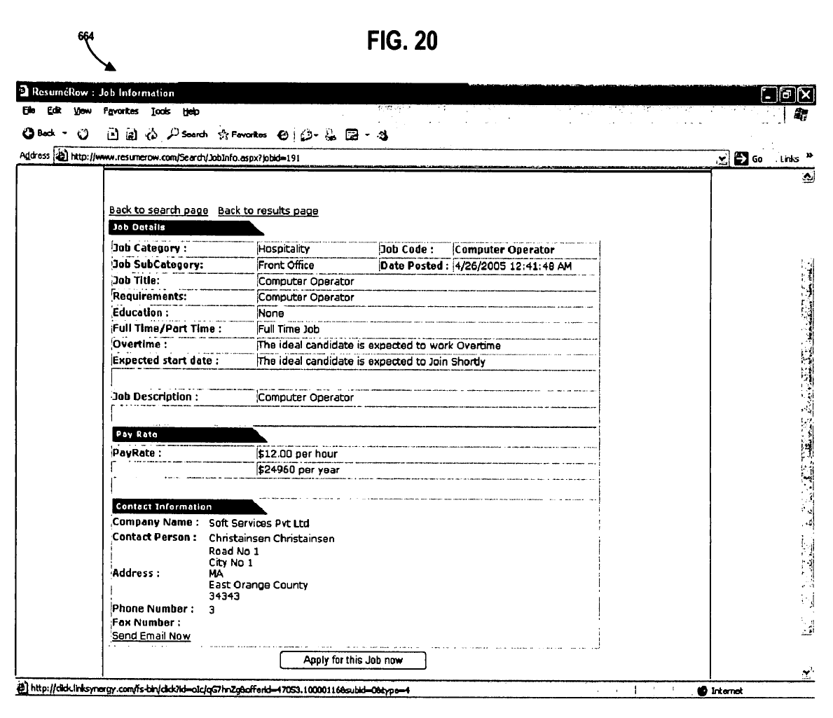

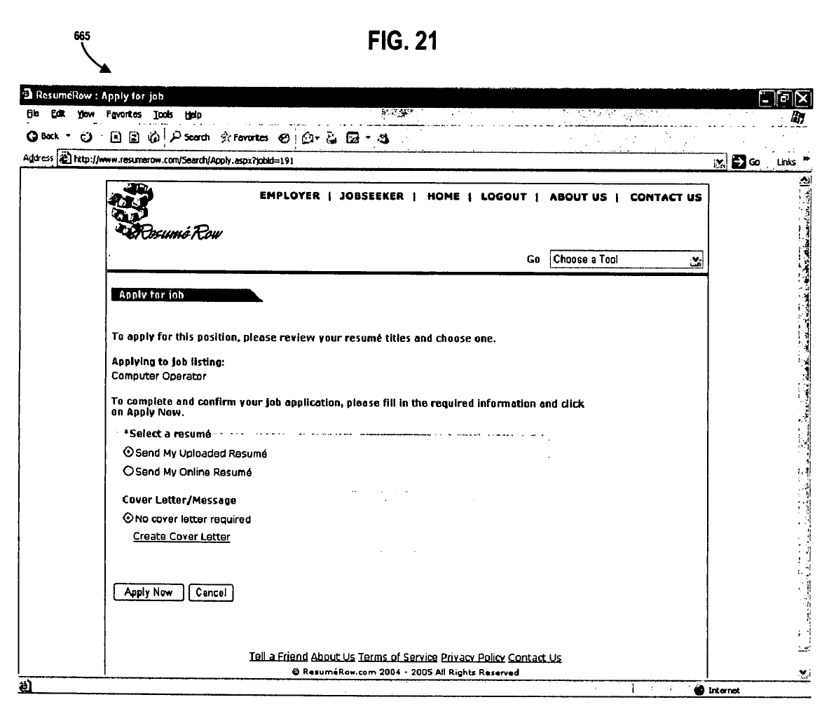

Referring again to FIG. 6, the job seeker may find a posted job through the search and decide to apply for the job at block 665. FIGS. 19-21 depict exemplary screen shots of results from a job search and applying for a particular posted job according to an exemplary embodiment of the invention. Referring again to FIG. 6, the job seeker may then be prompted at block 666 to create and/or update a job search profile if not previously completed. The job seeker may view, at block 667, the first set of decision information 553 selected by the employer who posted the job and may select, at block 668, a second set of criteria 670 from a predetermined set of criteria 669 based on the first set of decision information 553. The second set of criteria 670 may be selected by the job seeker from the predetermined set of criteria 555 by use of known selection tools such as, for example, a pull-down menu, a radio button, or a text box. The first set of decision information 553 is described in more detail above, with regard to FIG. 5. The predetermined subset of criteria 669 based on the first set of decision information 553 may include all or some of the predetermined set of criteria 555 based on the predetermined set of decision information 552.

As another example, referring to FIG. 6, the second set of criteria 670 based on the first set of decision information 553 may include, for example: New York, N.Y.; a preferred salary range of between $50,000 per year to $90,000 per year; an online verification of a minimum typing speed of 80 words per minute; and a preference for full-time job status. The second set of criteria 670 based on the first set of decision information 553 may be stored in the user database 213 (not shown in FIG. 6) and may be associated with the job seeker. The second set of criteria 670 may also be compared to an employer's job profile as further discussed below with respect to FIG. 7.

FIG. 7 depicts a flowchart of an exemplary data comparison process according to an exemplary embodiment of the present invention. In a data comparison process 700, the first set of criteria 556 and at least one of the second set of criteria 663 based on the predetermined set of decision information 552 and/or the second set of criteria 670 based on the first set of decision information 553, may be compared at block 780. The comparison at block 780 may determine whether there is a match at block 781 between first set of criteria 556 and at least one of the second set of criteria 663 based on the predetermined set of decision information 552 and/or the second set of criteria 670 based on the first set of decision information 553. In one exemplary embodiment, the first and second sets of criteria may be required to match perfectly. In another exemplary embodiment, however, the first and second sets of criteria may be compared for a substantial match such as, for example, but not limited to, an 80% or greater match, or some other exemplary threshold, or the like.

In an exemplary embodiment of the invention, the comparison at block 780 may be performed by a computer such as, for example, one of the employer computer 101, the job seeker computer 103, or the remote computer 104 described above with regard to FIG. 1. For example, the remote computer 104 may run a software comparison program to retrieve data from one or both of user database 213 or job database 224 in order to make the comparison at block 780.

If there is no match at block 781 between the first set of criteria 556 and one of the second set of criteria 663 based on the predetermined set of decision information 552 or the second set of criteria 670 based on the first set of decision information 553, the remote computer 104, for example, may not forward information associated with the job seeker to the employer and/or may not show a complete description of the job to the job seeker, as indicated at block 782. The information associated with the job seeker may be information such as, for example, a resume. The resume may be an uploaded document or may be a resume created by the job seeker in an exemplary embodiment of the system.

If there is a match, or a substantial match, between first set of criteria 556 and at least one of the second set of criteria 663 based on the predetermined set of decision information 552 and/or the second set of criteria 670 based on the first set of decision information 553, the remote computer 104, for example, may perform match processing at block 783. Match processing may include performing at least one of block 784 or block 785, or both. In one exemplary embodiment, the remote computer 104 may transmit information associated with the job seeker to the employer, as indicated at block 784. In another exemplary embodiment, the remote computer may transmit a notification of the match to the job seeker so as to allow the job seeker to manually transmit information to the employer, as indicated at block 785.

FIG. 8 depicts a flowchart of an exemplary online testing portion of a job search profile creation process according to an exemplary embodiment of the present invention. In an exemplary online testing portion 800 of job search profile creation process 600, the job seeker may be prompted at block 668 to select a second set of criteria 670 based on the first set of decision information 553. The first set of decision information 553 may, for example, require a minimum typing speed, as indicated at 890. The job database 224 and the user database 213 may be accessed in order to determine whether the particular job or employer requires a minimum typing speed. If the particular job or employer does not require a minimum typing speed at block 890, the job seeker may proceed in creating/updating his or her second set of criteria 670 based on the first set of decision information 553. If however, the particular job or employer does require a minimum typing speed at block 890, the job seeker may be directed to, or may be provided with a prompt or link to, an online verification and/or testing service such as, for example, a website entitled PROVE IT! available from KENEXA of Philadelphia, Pa., U.S.A., indicated at block 891, to allow the job seeker to verify, for example, his or her typing speed. Once the job seeker accesses the PROVE IT! service at block 891, he or she may take a typing speed test and the test results may be returned to the job seeker and/or the recruiting service via email, for example. The job seeker's job search profile may then be updated with the test results provided by PROVE IT! and the information may be stored in the user database 213 for later comparison.

Exemplary Definitions

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor or multiple processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a laptop, notebook, or other handheld device; a personal digital assistant (PDA); a portable telephone or other communications device; application-specific hardware to emulate a computer and/or software, such as, for example, a digital signal processor (DSP) or a field-programmable gate array (FPGA); a distributed computer system for processing information via computer systems linked by a network; two or more computer systems connected together via a network for transmitting or receiving information between the computer systems; and one or more apparatus and/or one or more systems that may accept data, may process data in accordance with one or more stored software programs, may generate results, and typically may include input, output, storage, arithmetic, logic, and control units.

A “computer system” may refer to a system having a computer, where the computer may include a computer-readable medium embodying software to operate the computer. The system may include hardware, software, firmware, a network and related components, as well as any combinations of these.

A “computer-readable medium” may refer to any storage device used for storing data accessible by the computer system. Examples of a computer-readable medium may include: a magnetic hard disk; a floppy disk; an optical disk, such as a CD-ROM and a DVD; a magneto-optical device; a magnetic tape; a flash memory; a memory chip; and a carrier wave used to carry computer-readable electronic data, such as those used in transmitting and receiving e-mail or in accessing a network. The computer-readable medium may be external to a computer system and/or internal to a computer system.

“Software” may refer to prescribed rules to operate a computer. Examples of software may include: software; code segments; instructions; computer programs; and programmed logic.

A “network” may refer to any number of computers and associated devices that may be connected by communication facilities. A network may involve permanent connections such as cables or temporary connections such as those made through telephone or other communication links. Examples of a network may include: an internet, such as the Internet; an intranet; a local area network (LAN); a wide area network (WAN); and a combination of networks, such as an internet and an intranet.

A “database” may refer to any collection of data or organized body of related information arranged for ease and speed of search and retrieval. Examples of a “database” may include: a deductive database, a distributed database, a functional database, an object-oriented database, and/or a relational database.

A “user interface” may provide input to and/or may receive output from a computer system. The user interface may include, for example, one or more of the following: a graphical user interface (GUI); a monitor; a mouse; a keyboard; a touch screen; a printer; a microphone; speakers and/or one or more other input and/or output devices. By using the user interface, a user may provide inputs to the computer system, including those needed to initialize the computer system, provide input to the computer system, and receive output from the computer system.

The embodiments illustrated and discussed in this specification are intended only to teach those skilled in the art the best way and exemplary other ways to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

What is claimed is:

1. A computer-based employment matching method comprising:
receiving electronically first computer-readable data from an employer via a computer network, the first computer-readable data representing a job profile including
a first set of decision information selected by the employer from a predetermined set of decision information, and
a first set of criteria selected by the employer from a predetermined set of criteria based on the first set of decision information;
receiving electronically second computer-readable data from a job seeker via a computer network, the second computer-readable data representing a job search profile;
comparing the second computer-readable data to the first computer-readable data; and
transmitting electronically at least one of (a) information associated with the job seeker to the employer and/or (b) a notification to the job seeker to transmit information associated with the job seeker to the employer, if the second computer-readable data substantially matches the first computer-readable data.

2. The computer-based employment matching method according to claim 1, wherein said job search profile includes a second set of criteria selected by the job seeker from the predetermined set of criteria based on the predetermined set of decision information.

3. The computer-based employment matching method according to claim 1, wherein said job search profile includes a second set of criteria selected by the job seeker from the predetermined set of criteria based on the first set of decision information.

4. The computer-based employment matching method according to claim 1, wherein the information associated with the job seeker is a resume.

5. The computer-based employment matching method according to claim 1, further comprising storing the first computer-readable data from the employer in a database.

6. The computer-based employment matching method according to claim 1, further comprising storing the second computer-readable data from the job seeker in a database.

7. The computer-based employment matching method according to claim 1, wherein the predetermined set of decision information is selected from the group consisting of: salary information, job location information, commuting distance information, drug testing information, credit report information, criminal information, computer skills information, mode of transportation information, language information, hourly requirements information, and test scores information.

8. The computer-based employment matching method according to claim 1, wherein the predetermined set of criteria includes verification information, the method further comprising
obtaining the verification information from an information verification service.

9. The computer-based employment matching method according to claim 8, wherein the verification information includes a minimum typing speed test.

10. A computer-based employment matching system comprising:
a data receiving module adapted to electronically receive first computer-readable data from an employer via a computer network, the first computer-readable data representing a job profile including a first set of decision information selected by the employer from a predetermined set of decision information and a first set of criteria selected by the employer from a predetermined set of criteria based on the first set of decision information;
the data receiving module further adapted to electronically receive second computer-readable data from a job seeker via a computer network, the second computer-readable data representing a job search profile;
a comparing module adapted to compare the first computer-readable data to the second computer-readable data; and
a transmitting module adapted to electronically transmit at least one of (a) information associated with the job seeker to the employer and/or (b) a notification to the job seeker to transmit information associated with the job seeker to the employer, if the first computer-readable data matches the second computer-readable data.

11. The computer-based employment matching system according to claim 10, wherein said job search profile includes a second set of criteria selected by the job seeker from the predetermined set of criteria based on the predetermined set of decision information.

12. The computer-based employment matching system according to claim 10, wherein said job search profile includes a second set of criteria selected by the job seeker from the predetermined set of criteria based on the first set of decision information.

13. The computer-based employment matching system according to claim 10, wherein the information associated with the job seeker is a resume.

14. The computer-based employment matching system according to claim 10, further comprising a database to store the first computer-readable data from the employer.

15. The computer-based employment matching system according to claim 10, further comprising a database to store the second computer-readable data from the job seeker.

16. The computer-based employment matching system according to claim 10, wherein the predetermined set of decision information is selected from the group consisting of: salary information, job location information, commuting distance information, drug testing information, credit report information, criminal information, computer skills information, mode of transportation information, language information, hourly requirements information, and test scores information.

17. The computer-based employment matching system according to claim 10, wherein the predetermined set of criteria includes verification information from an information verification service.

18. The computer-based employment matching system according to claim 17, wherein the verification information includes a minimum typing speed test.

19. A computer-readable medium comprising:
first computer-readable instructions adapted to instruct a computer to electronically receive first computer-readable data from an employer via a computer network, the first computer-readable data representing a job profile including a first set of decision information selected by the employer from a predetermined set of decision information and a first set of criteria selected by the employer from a predetermined set of criteria based on the first set of decision information;
second computer-readable instructions adapted to instruct the computer to electronically receive second computer-readable data from a job seeker via a computer network, the second computer-readable data representing a job search profile;
third computer-readable instructions adapted to instruct the computer to compare the first computer-readable data to the second computer-readable data; and
fourth computer-readable instructions adapted to instruct the computer to electronically transmit one of (a) information associated with the job seeker to the employer if the first computer-readable data matches the second computer-readable data or (b) a notification to the job seeker to transmit information associated with the job seeker to the employer if the first computer-readable data matches the second computer-readable data.

20. A method comprising utilizing the computer-based employment matching system according to claim 10.
